(19) United States
(12) Patent Application Publication
(10) Pub. No.: US 2013/0195114 A1
(43) Pub. Date: Aug. 1, 2013

(54) COMMUNICATION SYSTEM AND METHOD FOR ISOCHRONOUS DATA TRANSMISSION IN REAL TIME

(71) Applicants: Gunnar Lessmann, Nieheim (DE); Carsten Pieper, Lippetal (DE); Sebastian Schriegel, Steinheim (DE); Eugen Breit, Blomberg (DE); Markus Schumacher, Borchen (DE)

(72) Inventors: Gunnar Lessmann, Nieheim (DE); Carsten Pieper, Lippetal (DE); Sebastian Schriegel, Steinheim (DE); Eugen Breit, Blomberg (DE); Markus Schumacher, Borchen (DE)

(73) Assignee: PHOENIX CONTACT GMBH & CO. KG, Blomberg (DE)

(21) Appl. No.: 13/809,195

(22) PCT Filed: Jul. 7, 2011
(86) PCT No.: PCT/EP2011/003380

§ 371 Date: Mar. 25, 2013

(30) Foreign Application Priority Data
Jul. 14, 2010 (DE) 10 2010 027 167.5
Nov. 25, 2010 (DE) 10 2010 052 322.4

(51) Int. Cl. H04L 12/40

(52) U.S. Cl. CPC H04L 12/40013
USPC 370/401

(57) ABSTRACT

A communication system which has a PROFINET IRT system with first communication devices for isochronous transmission. A special IRT bridge device is created, so that a traditional standard Ethernet communication device can also transmit real time-critical data over the PROFINET IRT system. The bridge device has a timer, which is synchronized in time with the timers of the first communication devices. In addition, a device for analysis of the transmission point in time of a real time-critical data telegram received by the communication device and a control unit are provided, such that the control unit controls the forwarding of the respective real time-critical data telegram to at least one second communication device as a function of the analyzed transmission point in time.

### FIELD OF THE INVENTION

The present invention relates to a communication system as well as a method for isochronous transmission of real time-critical data over a real time-controlled Ethernet data network having at least one first communication device with a synchronized timer and is designed to transmit real time-critical data telegrams using a scheduled real time control.

Such a real time-controlled Ethernet data network is defined by the PROFINET IRT Standard, for example.

### BACKGROUND OF THE INVENTION

For some time now, Ethernet-based data networks which enable cycle times of a few milliseconds have been in use as field buses in automation systems. However, there are applications such as control of complex drive systems, which require much shorter communication cycles in the millisecond range, for example. The control of the drive systems is extremely time critical, i.e., they must be triggered at certain times to prevent malfunctions. A communication system that can transmit real time-critical data in short communication cycles is therefore needed.

To be able to use the Ethernet technology in real time-critical systems, the above-mentioned PROFINET IRT Standard has been introduced. The abbreviation IRT here stands for Isochronous Real Time, i.e., a technology which permits a clock-controlled data transmission in real time.

PROFINET IRT systems make it possible to transmit real time-critical and non-real time-critical data in communication cycles of an adjustable chronological length over a switchable Ethernet data network. To do so, each communication cycle is subdivided into a first time domain, in which real time-critical data can be transmitted, and a second time domain, in which non-real time-critical data can be transmitted. To be able to ensure the required time precision in such a system, the points in time of transmitting or relaying the real time-critical data or real time-critical data telegrams are scheduled. The PROFINET IRT Standard provides in this regard that the forwarding, sending and receiving points in time of the real time-critical data telegrams to be transmitted are saved in all participating coupling equipment and consumers, which capable of relaying, sending and/or receiving the real time-critical data telegrams, and namely more advantageously before the start of the data transmission. Coupling equipment and consumers must therefore be capable of forwarding and/or sending PROFINET IRT data telegrams in the millisecond range. To be able to maintain the precision scheduling of times for transmission and forwarding, the coupling equipment and consumers need special hardware components, which are available on the market. In particular each IRT-capable coupling unit and each IRT-capable consumer have their own clocks, which are synchronized with one another using an essentially known standardized method. Such a method is defined by the IEEE 1588 standard, for example. In order not to interfere with or endanger the required time precision within PROFINET IRT systems, non-IRT-capable equipment, for example, standard Ethernet devices must not be used between the IRT-capable coupling equipment and IRT-capable consumers.

The detailed design and functioning of such a real time-controlled Ethernet data network according to the PROFINET IRT Standard are disclosed in EP 1 388 238 B1, for example, and are sufficiently well known by those skilled in the art.

### SUMMARY OF THE INVENTION

The present invention is now based on the problem providing a communication system and a method for isochronous data transmission with which components that are not capable of a real time-controlled data transmission can transmit real time-critical data over a real time-controlled Ethernet data network without any impairment of the time precision required for the real time-critical data transmission.

A basic idea of the present invention is to link up traditional communication equipment such as computers and the like which are not capable of a real time-controlled data transmission and would nevertheless like to enable real time-critical data transmission via a special bridge device to a real time-controlled Ethernet data network, for example, a PROFINET IRT system. Such communication equipment has only a communication interface, for example, a standard Ethernet interface which is not suitable for transmission of real time-critical data with the time precision required for this purpose. Furthermore, standard Ethernet communication equipment often cannot be expanded through additional cards because no more expansion sites are available due to the deep integration of Ethernet interfaces.

According to this, a communication system for isochronous data transmission is provided, comprising a real time-controlled Ethernet data network with at least one first communication device having a synchronized timer. The first communication devices are designed to transmit real time-critical data telegrams using a scheduled real time control. It should be pointed out that the first communication device may be designed as a coupling device, as a consumer or as a component having a consumer with an integrated coupling unit. In addition, a communication system comprises at least one bridge device connected to the real time-controlled Ethernet data network. At least one second communication device is connected to the bridge device by means of a non-real time-controlled communication link. Such a communication link may be a standard Ethernet connection. The second communication device has a device for supplying real time-critical data telegrams, each containing a predetermined transmission point in time and a communication interface for transmitting real time-critical data telegrams to the bridge device. The communication interface, for example, a standard Ethernet interface, a USB interface, a WLAN interface, a FireWire interface or a PCI interface—none of these support real time-controlled data transmission. The bridge device in turn has a timer that is synchronized with the timers of the first communication devices, for example, being time synchronized or cycle synchronized. In addition, the bridge device contains another device for analyzing the transmission point in time of a real time-critical data telegram coming from the second communication device and a control device which controls the forwarding of the respective real time-critical data telegram to the at least one first communication device of the Ethernet data network as a function of the transmission point in time analyzed.

It should be pointed out here that an isochronous data transmission is understood to be a transmission of data in communication cycles with a predefined adjustable duration. One advantage of this communication system may be seen in the fact that the second non-real time-controllable communication device can transmit real time-critical data to the real time-controlled Ethernet data network without disturbing the time precision required for the real time-controlled Ethernet data network. It should be emphasized here that the bridge device for relaying the real time-critical data telegrams coming from the first communication device does not require a transmission schedule.

To be able to control the forwarding of incoming real time-critical data telegrams in the bridge device at high data traffic levels, phase information is advantageously also contained in the real time-critical data telegrams supplied by the second communication device. The phase information, also known as the cycle number, denotes a certain communication cycle within the Ethernet data network. The transmission point in time which is also transmitted in such a real time-critical data telegram thus indicates the transmission point in time with respect to the defined communication cycle. In this way, real time-critical data belonging together can be sent in multiple communication cycles. The analysis unit is therefore designed for analyzing the phase information of a received real time-critical data telegram. The control unit of the bridge device controls the forwarding of the respective real time-critical data telegram in the desired communication cycle to the at least one first communication device as a function of the analyzed transmission point in time and the analyzed phase information.

An advantageous embodiment provides that the real time-controlled Ethernet data network forms a PROFINET IRT Ethernet data network. The PROFINET IRT Ethernet data network is also referred to below as an IRT domain.

In this case, the first communication devices are designed according to the PROFINET IRT Standard. In addition, the real time-critical data telegrams supplied by the second communication device have a data structure according to the PROFINET IRT Standard. This ensures that the real time-critical data telegrams supplied by the second communication device can be forwarded unchanged to the Ethernet data network.

This is achieved in particular by the fact that the transmission point in time and/or the phase information is available at a predetermined location in the payload data field of the respective real time-critical data telegram. To do so, the start of the payload data is projected accordingly and the first communication device can easily mask out this information.

To be able to forward the real time-critical data telegrams arriving in the bridge device in a targeted manner, the number of a predetermined output port of the bridge device may be contained in each of the real time-critical data telegrams supplied by the second communication device. This achieves the result that the bridge device can output received real time-critical data telegrams at the selected output ports at the transmission point in time.

To permit a compact design of the communication system, the bridge device may be implemented in a first communication device.

Furthermore, the bridge device may also perform the function of a PROFINET synchronization master or synchronization slave.

The bridge device also has a memory device for temporary storage of real time-critical data telegrams of the second communication device. This ensures that no real time-critical data telegrams to be forwarded are lost in the bridge device when more real time-critical data telegrams are arriving than being sent, for example.

To also enable data transmission from the first communication device to the second communication device, the bridge device is designed for receiving real time-critical data telegrams generated by the first communication device and for forwarding these real time-critical data telegrams to the second communication device. In order for the second communication device to be able to determine the reception time of a real time-critical data telegram in this case, the bridge device is designed to write the reception time in a time critical data telegram coming from the first communication device.

According to this, a method for isochronous transmission of real time-critical data telegrams within a real time-controlled Ethernet data network is made available. The Ethernet data network comprises at least one first communication device that has a synchronized timer and is designed to transmit real time-critical data telegrams using a scheduled real time control.

First, at least one real time-critical data telegram is supplied to by a second communication device, wherein the real time-critical data telegram contains a predetermined transmission point in time. The real time-critical data telegram is transmitted over a communication interface of the second communication device to a bridge device connected to the Ethernet data network area. The communication interface, which may be a standard Ethernet interface, is not capable of real time-controlled data transmission. The bridge device has a timer, which is synchronized with the timer of the at least one first communication device. The transmission point in time transmitted in the received real time-critical data telegram is then analyzed in the bridge device and monitored with the help of the timer. The received real time-critical data telegram is forwarded by the bridge device to the at least one first communication device as soon as the transmission point in time has been reached.

The received real time-critical data telegram is expediently stored temporarily in the bridge device until the transmission point in time has been reached.

To enable a rapid forwarding of the real time-critical data telegram, the real time-critical data telegram is forwarded already after the analysis of the transmission point in time, namely before being completely received by the bridge device.

To be able to efficiently forward coherent real time-critical data, phase information which defines the communication cycle within the Ethernet data network is also contained in the real time-critical data telegram supplied by the second communication device. The phase information contained in the received real time-critical data telegram is analyzed in the bridge device. The real time-critical data telegram is forwarded by the bridge device to at least one first communication device, namely in the defined communication cycle and at the defined transmission point in time.

To be able to efficiently forward real time-critical data telegrams within the bridge device when there is a high level of traffic, it is advantageous to write the number of an output port of the bridge device in the real time-critical data telegram being supplied. Then the output port number contained in the received real time-critical data telegram is analyzed in the bridge device and next the real time-critical data telegram is forwarded via the selected output port of the bridge device to the corresponding first communication device, namely in the defined communication cycle and at the defined transmission point in time.

In an advantageous embodiment, the real time-controlled Ethernet data network forms a PROFINET IRT domain. In this case, the first communication devices are designed according to the PROFINET IRT Standard. In addition, the real time-critical data telegrams supplied by the first and/or second communication devices have a data structure according to the PROFINET IRT Standard.

To be able to transmit unchanged the real time-critical data telegrams supplied by the second communication device through the Ethernet data network, the transmission point in time and/or the phase information and/or the output port number is/are written at a predetermined location within the payload data field of the real time-critical data telegram.

Since the transmission point in time, the phase information and/or the output port number in the Ethernet data network are no longer needed, this data can be removed from the real time-critical data telegram before the latter is forwarded.

### BRIEF DESCRIPTION OF THE DRAWINGS

The present invention will now be explained in greater detail below on the basis of an exemplary embodiment in conjunction with the accompanying drawings, in which:

FIG. 1 shows an exemplary communication system, in which the invention is implemented,

FIG. 2 shows a detailed block diagram of the IRT bridge shown in FIG. 1,

FIG. 3 shows the data structure of a PROFINET IRT data telegram,

FIG. 4 shows a modified data structure of the data telegram illustrated in FIG. 3 in which the transmission point in time and phase information are written into the payload data field, and

FIG. 5 time charts to illustrate the functioning of the IRT bridge.

### DETAILED DESCRIPTION

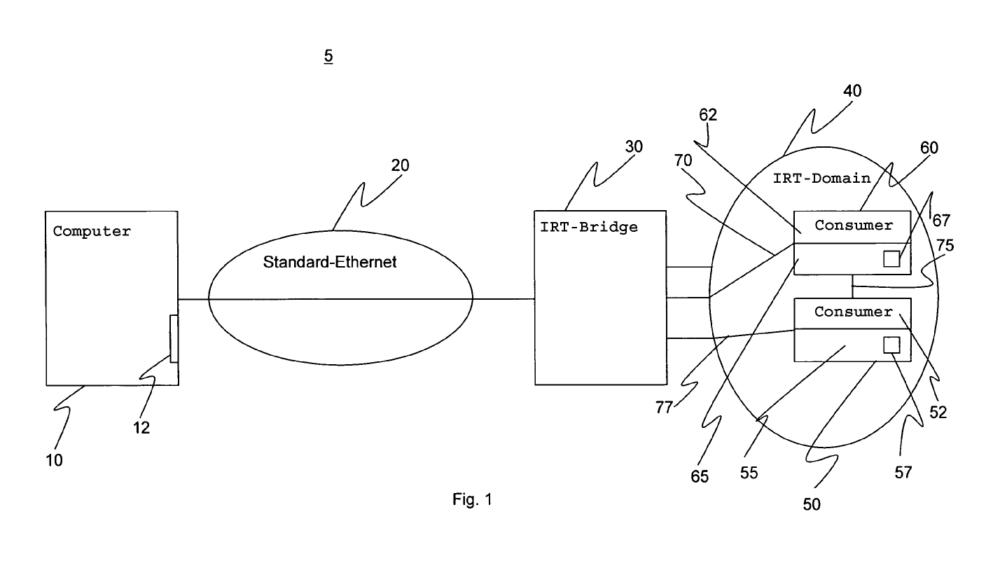

FIG. 1 shows an example of a communication system 5, which can be used to control complex industrial drive systems in an automation environment. For control of such drive systems, it must be possible to transmit real time-critical data in very short cycle times, for example, in the μs range. To this end, a real time-capable data transmission system on an Ethernet basis was developed under the name PROFINET IRT, which was mentioned with its essential features in the introduction to the description. Such a PROFINET IRT system is preferably a component of the communication system 5. This system is labeled with reference numeral 40 in FIG. 1. This area of the communication system 5 is referred to below as an IRT domain or a real time-controlled Ethernet data network 40. The data network 40 may be a switched Ethernet data network. Those skilled in the art will be familiar enough with the design and functioning of a PROFINET IRT system, so that a detailed description is not necessary at this point. Such a PROFINET IRT system is disclosed in EP 1 388 238 B1 in particular.

The real time-controlled Ethernet data network 40, which is only diagramed schematically in FIG. 1, is indicated by three Ethernet connections 70, 75 and 77, to which are connected, for example, two IRT-capable, i.e., real time-controllable communication devices 50 and 60. Each of these IRT-capable communication devices 50, 60 comprises a consumer 52 or 62, respectively, and has an essentially known coupling device 55 or 65, respectively. The consumers 52 and 62 may be essentially known IRT IO devices (slaves) such as actuators, sensors, drive systems and the like, IRT IO controllers (masters), computers and the like. It should be pointed out that consumers and coupling devices may also be separate communication devices.

To ensure a real time-controlled data transmission within the IRT domain 40, schedules containing the transmission point in time for forwarding the real time-critical data telegrams to be transmitted are stored in the coupling devices 55 and 65 in the present case. The coupling devices 55 and 65 are therefore also referred to as IRT-capable coupling devices. The connecting links which belong to the transmission points in time and by which the real time-critical data telegrams are also forwarded may optionally also be saved. The schedules are advantageously created before the actual data transmission and stored in the coupling devices. Each IRT-capable coupling devices 55 and 65 thus knows when and at which output port a real time-critical data telegram is to be sent or forwarded. To determine the precise transmission point in time, each coupling device 55 and 65 has its own clock 57 and/or 67. These two clocks are synchronized with one another. The data to be transmitted is transmitted in communication cycles with an adjustable duration. Each communication cycle is subdivided into two time domains. The real time-critical data telegrams are transmitted in the first time domain, and the non-real time-critical data telegrams are transmitted in the second time domain. The points in time when real time-critical data telegrams can be transmitted within the first time domain of a communication cycle are also fixedly predetermined. PROFINET IRT systems operate with a time precision in the μs range. Specially designed coupling devices 55 and 65 are needed to achieve this transmission accuracy. Corresponding modules with which the precise scheduling of the real time communication is ensured are already available on the market.

EP 1 388 238 B1 also discloses that consumers having only a standard Ethernet interface may be connected to an Ethernet connection of the IRT domain 40. These consumers generate only non-real time-critical data that is transmitted exclusively in the second time domain of a communication cycle without interference in the real time communication.

As already explained above, special IRT-capable hardware is required in the communication devices 50 and 60 to be able to transmit real time-critical data. Because of the deep integration of standard Ethernet interfaces, numerous communication devices, for example, PC architectures, no longer have any free expansion slots, so they cannot be used for a real time-critical data transmission within the IRT domain.

With the communication system 5 shown in FIG. 1, it is now possible for even devices that do not have IRT-capable equipment but instead only have a communication interface which does not support real time-controlled data transmission to supply real time-critical data telegrams that can be transmitted over the IRT domain 40. Such a communication interface in the present example is a standard Ethernet interface. This does not interfere with the real time-critical data communication guaranteed by the PROFINET IRT system.

This achieves the result that standard Ethernet devices may be connected to the IRT domain 40 via an IRT bridge device 30. The IRT bridge device 30 may also be referred to as a modified Ethernet switch.

FIG. 1 shows a non-IRT-capable communication device, for example, a traditional standard Ethernet computer 10. The computer 10 contains only one standard Ethernet interface 12 by means of which it is connected to the IRT bridge device 30 via an Ethernet cable of a standard Ethernet data network 20. It should be pointed out that multiple standard Ethernet devices can be connected to the IRT bridge device 30 or to another IRT bridge device via the standard Ethernet data network 20. The term “standard Ethernet data network” expresses the fact that real time-critical data cannot be transmitted with a high time precision over such a data network. It should be pointed out that in the present case the standard Ethernet data network and the standard Ethernet computer are used only as examples of devices that do not have any IRT capability.

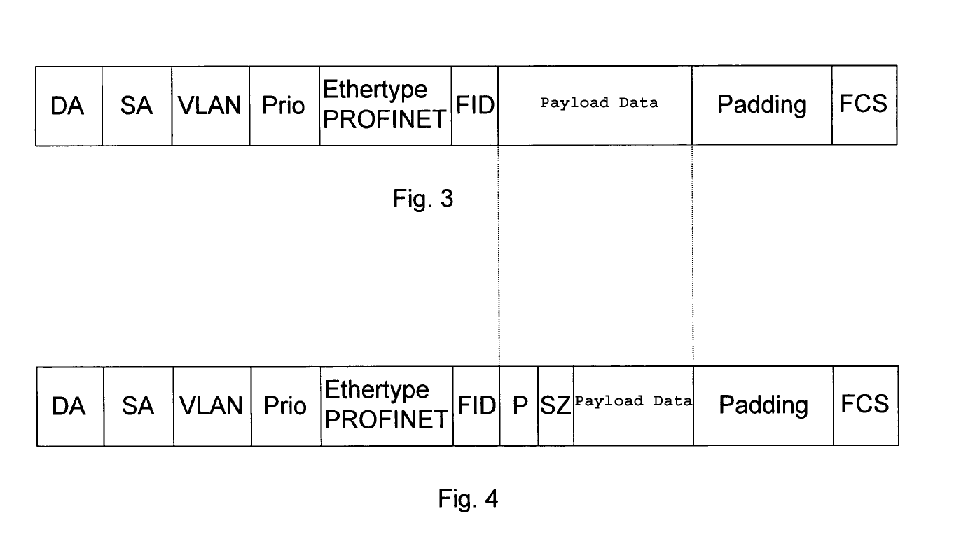

The computer 10 is designed to generate PROFINET IRT-compatible data telegrams, which can be transmitted over the IRT domain 40. FIG. 3 shows an example of a data structure of a PROFINET IRT data telegram. The IRT-capable communication devices 50 and 60 can transmit such data telegrams. The PROFINET IRT data telegram shown here contains a header, which has the destination address DA and the source address SA, for example. Instead of the destination address DA, an MCFF address which supports the MultiCast Fast Forwarding Technology of the PROFINET IRT system, which is known per se, may also be used. The “VLAN” and “PRIO2” data fields serve to control non-real time-critical data telegrams. The coupling devices 55 and 65 and also the IRT bridge device 30 can recognize PROFINET IRT data telegrams on the basis of the data fields “Ethernet-type PROFINET” and “FID.” In addition, the PROFINET IRT data telegram shown here contains a payload data field, a padding field and a checksum field FCS. The padding field is necessary so that the data telegram is no less than 64 bits even if the payload data length is smaller. Ethernet compatibility can therefore be guaranteed. As already mentioned, the coupling devices 55 and 65 have schedules which stipulate precisely when a PROFINET IRT data telegram is to be sent. No such schedule is provided in the IRT bridge device 30.

It is now necessary to ensure that the real time-critical data telegrams coming from computer 10 can be transmitted by the IRT bridge device 30 without any interference in the schedules applicable in the IRT domain 40. This is achieved by designing the computer 10 and the IRT bridge device 30 accordingly.

The computer 10 has software, which enables it to write the desired transmission point in time SZ and optionally a phase information P in the payload data field of a PROFINET IRT data telegram to be transmitted, which has the data structure shown in FIG. 4. The phase information P corresponds to the number of a communication cycle within the IRT domain 40. In addition, the computer 10 can also write the number of an output port of the IRT bridge device 30 in the payload data field. The phase information P, the transmission point in time SZ and the output port number stand at a predetermined location within the payload data field, so that the IRT bridge device 30 can read this information out of the payload data field of a received data telegram.

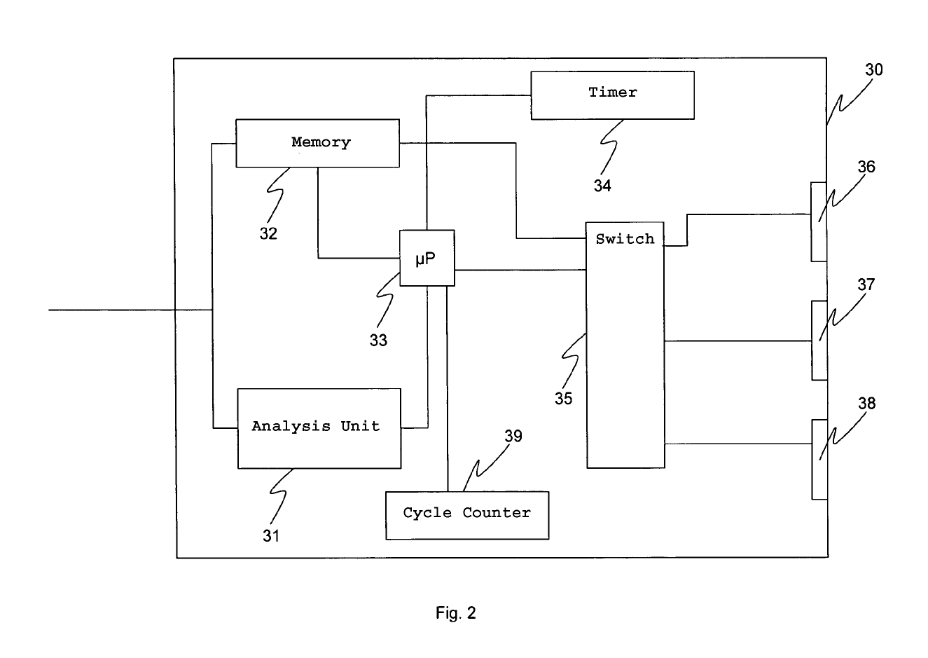

The basic design of the IRT bridge device 30 is shown in FIG. 2. The IRT bridge device 30 has an analysis unit 31, which can analyze the transmission point in time, the output port number and the phase information contained in the payload data field of a received PROFINET IRT data telegram. It should be emphasized here that the transmission point in time, the phase information and the output port number are all information for the IRT bridge device for time control of real time-critical data telegrams of the computer 10.

In addition, the IRT bridge device 30 has a memory 32, in which the data telegrams coming from the computer 10, which may be real time-critical and non-real time-critical data telegrams, are stored temporarily. In addition, a timer 34, which is synchronized in time with the timers 57 and 67 of the coupling devices 55 and 65, is also provided. Methods of synchronizing the timers in a PROFINET IRT system are sufficiently well known and therefore need not be described further here. It is important only that these timers are synchronized with a high precision, i.e., in the μs range, for example, to enable a chronologically precise control of drive systems. In addition, the IRT bridge device 30 may have a switching device 35, which can send real time-critical data telegrams that are to be forwarded to a certain output port of the IRT bridge device 30 as a function of the output port number contained in the payload data field. In the present example, the IRT bridge device 30 has three output ports 36, 37 and 38. Control and monitoring of the IRT bridge device 30 and its components may be executed by a programmable control unit, for example, a microprocessor 33. Furthermore, a cycle counter 39 may also be provided in the IRT bridge device 30 and can be synchronized with a cycle counter of the IRT domain 40, known as a CycleCounter.

The functioning of the communication system 5 and in particular the functioning of the IRT bridge device 30 are explained in greater detail below.

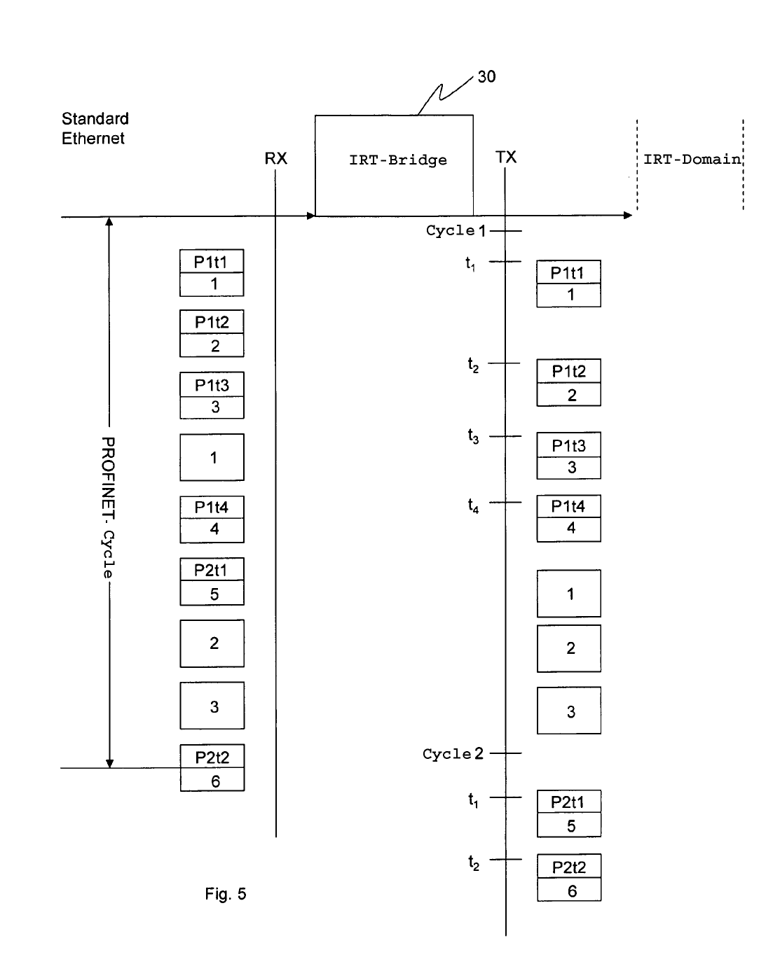

It should first be assumed that the computer 10 would like to transmit multiple real time-critical PROFINET IRT data telegrams and non-real time-critical data telegrams over the standard Ethernet interface 12. These data telegrams are transmitted, for example, over the standard Ethernet data network 20 to the IRT bridge device 30 in communication cycles according to the non-real time-capable PROFINET IRT Standard. As shown in the time chart on the left in FIG. 5, the computer 10 sends six real time-critical modified PROFINET IRT data telegrams, for example, over its standard Ethernet interface 12, the data structure of which is shown in FIG. 4 as an example, and sends three non-real time-critical data telegrams in a communication cycle to the IRT bridge device 30. To do so, the computer 10 writes at least the desired transmission point in time in the payload data field of each real time-critical data telegram. In the present example, the computer 10 writes the phase information P1 and the transmission point in time t1 into the payload data field of the first real time-critical data telegram. This information goes to the IRT bridge device 30 of the communication cycle and the transmission point in time within this communication cycle when the real time-critical data frame must be transmitted. Similarly, the computer 10 writes the phase information P1 and a different point in time t2 in the payload data field of the second real time-critical data telegram to be transmitted. The computer 10 writes the phase information P1 and the transmission point in time t3 in the payload data field of the third real time-critical data telegram to be transmitted while the payload data field of the fourth real time-critical data telegram to be transmitted contains the phase information P1 and the transmission point in time t4. In other words, the first four real time-critical data telegrams should be forwarded at four different times within the first communication cycle from the IRT bridge device 30 to the IRT domain 40. The payload data field of the fifth real time-critical data telegram to be transmitted contains the phase information P2 and the transmission point in time t1. The phase information P2 indicates that this real time-critical data telegram must be transmitted in the second communication cycle of the IRT domain 40. Finally, the payload data field of the sixth data telegram to be transmitted contains the phase information P2 and the transmission point in time t2. These six real time-critical data telegrams to be transmitted may all have the data structure of a modified PROFINET IRT data telegram as shown in FIG. 4.

The output port number which indicates over which of the three output ports 36, 37 and 38 the respective real time-critical data telegram is to be transmitted may optionally be contained in the payload data field of the six real time-critical data telegrams to be transmitted. In the present example, it is assumed that the payload data fields do not contain any output port number. For this application case, the IRT bridge device 30 may be adjusted so that all real time-critical data telegrams are sent over the output port 36 to the IRT domain 40.

The analysis unit 31 can recognize the real time-critical data telegrams of the computer 10 on the basis of the “Ethernet-type PROFINET” and “FID” fields. When the analysis device 31 ascertains that the first real time-critical data telegram of the computer 10 has arrived, it reads the transmission point in time t1 and the phase information P1 out of the predetermined location in the payload data field. Similarly, the analysis unit 31 analyzes the five additional real time-critical data telegrams of the computer 10. Some or all of the data telegrams of the computer 10 may be stored in the memory 32 of the IRT bridge device 30. In addition, the information that has been analyzed and an identification of the respective real time-critical data telegrams can be saved in a lookup table in the IRT bridge device 30. The microprocessor 33 monitors the timer 34, the cycle counter 39 and optionally the lookup table.

It should be pointed out here once again that the communication cycles of the IRT domain 40 each have a first range in which real time-critical data telegrams are transmitted and a second range in which non-time-critical data telegrams are transmitted. As shown by the time chart on the right in FIG. 5, the first time domain of a communication cycle of the IRT domain 40 comprises four transmission points in time T1, T2, T3 and T4, which are fixedly defined.

As soon as the microprocessor 33 has recognized that the transmission point in time t1 contained in the first real time-critical data telegram corresponds to the current time of the timer 34, and the phase information P1 corresponds to the current value of the cycle counter 39, then the first real time-critical data telegram is sent via the switch 35 to the output port 36 and from there is forwarded to the IRT domain 40 at time t1 in the first communication cycle. Depending on the destination address DA, the data telegram is transmitted to the consumer 62, for example. Similarly, the microprocessor 33 ensures that the second real time-critical data telegram is forwarded to the IRT domain 40 at the transmission point in time t2 of the first communication cycle, the third real time-critical data telegram is forwarded at the transmission point in time t3 of the first communication cycle and the fourth real time-critical data telegram is transmitted at the transmission point in time t4 of the first communication cycle. Next the three non-real time-critical data telegrams of the computer 10 may be forwarded to the IRT domain 40 in the second time domain of the first communication cycle, as shown in FIG. 5. The IRT bridge device 30 recognizes the non-real time-critical data telegrams of the computer 10 on the basis of the data in the “VLAN” and “PRIO” fields of a PROFINET IRT data telegram. The PROFINET rules for transmission of non-real time-critical data telegrams, which are essentially known, are taken into account here by the IRT bridge device 30.

In response to the results of the analysis device 31, which may be stored in the lookup table mentioned above, the microprocessor 33 knows that the fifth and sixth real time-critical data telegrams must be forwarded in the second communication cycle.

The microprocessor 33 still monitors the timer 34 and the cycle counter 39. As soon as the microprocessor 33 has recognized that the transmission point in time t1 contained in the fifth real time-critical data telegram corresponds to the current time of the timer 34, and that the phase information P2 corresponds to the current value of the cycle counter 39, the fifth real time-critical data telegram is read out of the memory 32 and sent via the switch 35 to the output port 36 and from there is forwarded to the IRT domain 40 at time t1 in the second communication cycle. Depending on the destination address DA, the data telegram is transmitted to the consumer 52, for example. Similarly, the microprocessor 33 ensures that the sixth real time-critical data telegram is forwarded to the IRT domain 40 at the transmission point in time t2 of the second communication cycle, as illustrated in FIG. 5.

It should be pointed out here that the real time-critical data telegrams can already be forwarded by the IRT bridge device 30 as soon as the analysis device 31 has analyzed the phase information P and the transmission point in time SZ without the respective data telegram having been completely received or already stored completely in the memory 32.

In addition, it is possible that the IRT bridge device 30 can forward unchanged the real time-critical data telegrams coming from the computer 10 to the IRT domain, depending on the implementation. Alternatively, it is conceivable that the IRT bridge 30 can remove the transmission point in time SZ and optionally the phase information P as well as the output number from the payload data field before forwarding a received real time-critical data telegram because this information is then no longer needed in the IRT domain 40.

Moreover, the IRT bridge device 30 may also be arranged inside the communication device 50 or 60, for example. It is also conceivable for the IRT bridge device to also be able to perform the function of a PROFINET synchronization master, which has long been known.

In addition, it should be pointed out that the coupling devices 55 and 65 know the exact position of the payload data within a PROFINET IRT data telegram and are thus capable of masking out the phase information and the transmission point in time within a payload data field. This permits transparent forwarding of the real time-critical data telegrams supplied by the computer 10 within the IRT domain without having to make any changes in the existing hardware.

Finally, it should be pointed out that the IRT-capable communication devices can transmit real time-critical data telegrams to the bridge device 30 according to the data structure shown in FIG. 3. Depending on the implementation, the bridge device 30 can write the respective reception time into the received real time-critical data telegrams before forwarding the data telegram to the computer 10.

What is claimed is:

1. A communication system for isochronous data transmission, comprising:
a real time-controlled Ethernet data network having at least one first communication device, which has a synchronized timer and is designed to transmit real time-critical data telegrams using a scheduled real time control;
at least one bridge device; and
at least one second communication device that is connected to the bridge device and has a device for supplying real time-critical data telegrams, each of which contains a predetermined transmission point in time, and that has a communication interface by means of which the real time-critical data telegrams are transmitted to the bridge device, wherein the communication interface does not support any real time-controlled data transmission, and
wherein the bridge device comprises:
(i) a timer, which is synchronized with the timer of the first communication device,
(ii) a device for analyzing the transmission point in time of a real time-critical data telegram received by the second communication device, and
(iii) a control device, which controls the forwarding of the respective real time-critical data telegram to the at least one first communication device of the Ethernet data network as a function of the analyzed transmission point in time.

2. The communication system according to claim 1, wherein the real time-critical data telegrams supplied by the second communication device each contain phase information, which defines the communication cycle within the real time-controlled Ethernet data network; and
wherein the analysis device is designed for analyzing the phase information of a real time-critical data telegram received by the second communication device and the control unit controls the forwarding of the respective real time-critical data telegram in the desired communication cycle to the at least one first communication device of the Ethernet data network as a function of the analyzed transmission time and the analyzed phase information.

3. The communication system according to claim 1, wherein the real time-controlled Ethernet data network forms a PROFINET IRT-based Ethernet data network;
wherein the at least one first communication device is designed according to the PROFINET IRT Standard; and
wherein the real time-critical data telegrams supplied by the second communication device have a data structure according to PROFINET IRT Standard.

4. The communication system according to claim 3, wherein the transmission point in time and/or the phase information appear(s) in a predetermined location in the payload data field of a respective real time-critical data telegram.

5. The communication system according to claim 1, wherein the number of a predetermined output port of the bridge device is contained in the real time-critical data telegrams supplied by the second communication device.

6. The communication system according to claim 1, wherein the bridge device is implemented in a first communication device.

7. The communication system according to claim 1, wherein the bridge device performs the function of a PROFINET synchronization master or a synchronization slave.

8. The communication system according to claim 1, wherein the bridge device has a memory device for temporary storage of real time-critical data telegrams received from the second communication device.

9. The communication system according to claim 1, wherein the bridge device is designed for reception of real time-critical telegrams, which are generated by the first communication device, and for forwarding these real time-critical data telegrams to the second communication device.

10. The communication system according to claim 9, wherein the bridge device is designed to write the respective reception time into the time-critical data telegrams arriving from the first communication device.

11. The communication system according to claim 1, wherein the communication interface is a standard Ethernet interface, a USB interface, a WLAN interface, a FireWire interface or a PCI interface.

12. A method of isochronous transmission of real time-critical data telegrams within a real time-controlled Ethernet data network, which contains at least one first communication device having a synchronized timer and is designed to transmit real time-critical data telegrams using a scheduled real time control, the method comprising:
supplying at least one real time-critical data telegram containing a predetermined transmission point in time;
sending the real time-critical data telegram over the communication interface of a second communication device to a bridge device, which is connected to the real time-controlled Ethernet data network and has a timer that is synchronized with the timers of the first communication devices, wherein the communication interface does not support a real time-controlled data transmission, and wherein the communication interface does not support any real time-controlled data transmission;
analyzing in the bridge device the transmission point in time that is transmitted in the received real time-critical data telegram;
monitoring the transmission point in time with the help of the timer; and
forwarding the received real time-critical data telegram from the bridge device to the at least one first communication device of the Ethernet data network as soon as the transmission point in time has been reached.

13. The method according to claim 12, wherein the received real time-critical data telegram is stored temporarily in the bridge device until the transmission point in time is reached.

14. The method according to claim 12, wherein the real time-critical data telegram is forwarded already after analysis of the transmission point in time and before it has been received completely in the bridge device.

15. The method according to claim 12, wherein the real time-critical data telegram supplied contains phase information, which defines the communication cycle within the Ethernet data network;
wherein the phase information contained in the received real time-critical data telegram is analyzed; and
wherein the real time-critical data telegram is forwarded from the bridge device to the at least one first communication device of the Ethernet data network in the defined communication cycle and at the defined transmission point in time.

16. The method according to claim 12, wherein the number of an output port of the bridge device is contained in the real time-critical data telegram supplied;
wherein the output port number contained in the received real time-critical data telegram is analyzed in the bridge device; and
wherein the real time-critical data telegram is forwarded via the selected output port of the bridge device to the at least one first communication device of the Ethernet data network in the defined communication cycle and at the defined transmission point in time.

17. The method according to claim 12, wherein the real time-controlled Ethernet data network forms a PROFINET IRT-based Ethernet data network;
wherein the at least one first communication device is designed according to the PROFINET IRT Standard; and
wherein the real time-critical data telegrams supplied by the second communication device have a data structure according to the PROFINET IRT Standard.

18. The method according to claim 17, wherein the transmission point in time and/or the phase information and/or the output port number is/are written in a predetermined location within the payload data field of the real time-critical data telegram.

19. The method according to claim 12, wherein the transmission point in time, the phase information and/or the output port number are removed from the real time-critical data telegram before forwarding of same.
